(19) United States
(12) Patent Application Publication
(10) Pub. No.: US 2008/0281655 A1
(43) Pub. Date: Nov. 13, 2008

(54) Systems And Methods For Helping Advertisers Take Advantage Of Co-Op Advertising Opportunities

(76) Inventors: Kirsten A. Mangers, Costa Mesa, CA (US); Kelly G. Stephen, Yorba Linda, CA (US); Carey K. Ransom, Newport Beach, CA (US); Ryan N. Anderson, San Clemente, CA (US); Paul Basile, Lone Tree, CO (US); Charles Terry DiNatale, Marietta, GA (US)

Correspondence Address: FISH & ASSOCIATES, PC;ROBERT D. FISH, 2603 Main Street, Suite 1050, Irvine, CA, 92614-6232, US

(21) Appl. No.: 12/017,459

(22) Filed: Jan. 22, 2008

Related U.S. Application Data
(60) Provisional application No. 60/917,247, filed on May 10, 2007.

(51) Int. Cl. G06Q 30/00; G06Q 10/00

(52) U.S. Cl. 705/7; 705/14

(57) ABSTRACT

Software is used to automate selection of suitable co-op advertising programs from among choices with which an advertiser has had no prior substantial business relationship, to facilitate production, distribution and tracking of advertisements that comply with the specific requirements of the selected co-op advertising program(s). Of particular interest are Internet Yellow Pages and search engine business indices, although ad-serving networks, and other partner advertising platforms/sites are also contemplated. Preferred systems and methods can be utilized by advertising agencies on behalf of their clients, which among other things allow the agencies to cost-effectively provide services to even very small clients. Different interface skins can be used for displaying summary customer tracking information to advertisers, advertising agencies, co-op program managers, national brand managers, media providers, and so forth.

This application claims priority to U.S. provisional appl. Ser. No. 60/917247 filed May 10, 2007.

### FIELD OF THE INVENTION

The field of the invention is electronic business directories.

### BACKGROUND

There are numerous electronic business directories upon which businesses can advertise their goods and services. One problem, however, is that each of the directories has its own specifications (formatting features including for example type size, border, and logo sizes) and standards (content restrictions including for example exclusion of adult materials, specific words and phrases, and restriction to particular industries). The complexity is such that many business operators find listing their goods and services to be cumbersome at best, and possibly even daunting.

Complexity is made considerably worse for businesses comparing cost-effectiveness of different directories, and is quite impossible for many businesses that consider spreading their advertising funds out among different directories, search engines and the like.

Businesses can sometimes reduce their advertising costs, or increase exposure for a given advertising budget, through use of a co-op advertising program. But in a great many cases businesses are unaware of such programs, and even if they had such awareness, they don't have the resources to effectively select, utilize and monitor the programs. The co-op advertising ‘industry’ is similarly disadvantaged in that they do not have any automated method to coordinate with companies that might utilize the co-op opportunities that they offer. Unless a business is part of a dealer or franchise network, the only access to such programs is through a thick book provided to the advertising agencies. And even if small businesses had direct access to the book, that access would prove largely useless because the book lists the programs in a completely non-parameterized, non-standardized format.

Advertising agencies are perfectly willing to assist business in all aspects of their advertising needs, including placement of electronic advertising in business directories, and helping advertisers identify co-op suitable advertising opportunities. However, the advertising/media budgets of many (or even most) businesses are just too small to be of interest to advertisement agencies. Moreover, the advertisement agencies have no effective tools that would increase their efficiency sufficiently to allow them to reach out to such businesses.

Of course, dealers and other advertisers already connected with a branding program already have access to co-op dollars available in their specific programs. A recent patent application, US 2003/0195802 to Hensen et al. (October 2003), teaches electronic interfaces for identifying suitable opportunities for such business, and even describes software for creating advertisements that would be acceptable to the brand sponsors. Hensen and all other extraneous materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

The teachings of Hensen, however, completely ignore the advertising needs of the vast majority of small businesses that are not dealers for a large corporation, or are otherwise not already connected with a branding program. Hensen also focuses on preparing standalone print and media advertisements, not the short blurbs found in electronic business directories.

Still further, Hensen offers nothing that would help a small business monitor success of its advertising campaign. There are many tools for monitoring advertising campaigns that use AdSense™ and similar products. Those tools, however, are not focused on advertising in electronic business directories. The software packages that are used by print yellow page publishers to produce the vast number of advertisements they include in their publications are not well suited to the needs of electronic advertising. They provide no tracking, for example, of customer responses. See YPA ELITE™, described at http://www.ypassociation.org/AM/Template.cfm?Section=ELITE.

Thus, there is still a need for systems and methods that address the electronic advertising needs of small businesses in identifying suitable co-op advertising opportunities, creating and implementing suitable advertisements for those opportunities in electronic business directories, and for monitoring the success of such advertising.

### SUMMARY OF THE INVENTION

The present invention provides systems and methods to facilitate advertising, preferably over a public package switched network, that capture advertiser-specific information for an advertiser, that provide an electronic interface for selection of suitable co-op advertising programs from among choices with which the advertiser has had no prior substantial business relationship, and a software tool that facilitate at least partially automated production of advertisements that comply with the specifications and standards of the selected electronic business index and co-op advertising program(s).

In preferred embodiments, the advertiser-specific information includes contact information associated with the advertiser, and perhaps a second logo different from the first logo. The advertiser's logo might or might not be associated with a national brand.

In another aspect, the system uses at least a first portion of the advertiser-specific information to select a listing of suitable co-op advertising programs. The automatically generated advertisements would typically include a logo of the advertiser, a logo from the co-op advertising program, and in some instances might also include a third logo associated from another, unrelated co-op advertising program. Different versions of the advertisement can be produced according to specifications and standards of different electronic business indices, and can be used in an advertising campaign that extends across multiple electronic business indices. Of particular interest are Internet Yellow Pages and search engine business indices, although ad-serving networks, and other partner advertising platforms/sites are also contemplated.

Preferred systems and methods can be utilized by advertising agencies on behalf of their clients, which among other things allow the agencies to cost-effectively provide services to even very small clients. Software tools, for example, can help determine where to place advertisements, estimate return on investment (ROI), provide bulk upload for transmitting unrelated advertisements to media providers. Another particularly useful feature is a provision for tracking and reporting customer responses to the advertisements. Different interface skins can be used for displaying summary customer tracking information to advertisers, advertising agencies, co-op program managers, a national brand managers, media providers, and so forth.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a schematic of a process that employs software to develop advertising content and formatting, upload the advertisements to publishers, and track results.

FIG. 2 is a screen shot of an interface through which an advertiser can enter contact and other account information.

FIG. 3 is a screen shot of an interface that displays different formats of an advertisement in conformance with specifications and standards of the chosen publishers.

FIG. 4 is a screen shot of an interface that displays requirements for a cooperative advertising program.

FIG. 5 is a screen shot of an interface through which a user selects which publishers will receive and publish an advertisement.

FIG. 6 is a screen shot of an interface that previews a given advertisement in formats for different publishers.

FIG. 7 is a screen shot of an interface that facilitates bulk upload of advertisements from multiple advertisers.

FIG. 8 is a screen shot of an interface that displays tracking information for a given advertisement.

### DETAILED DESCRIPTION

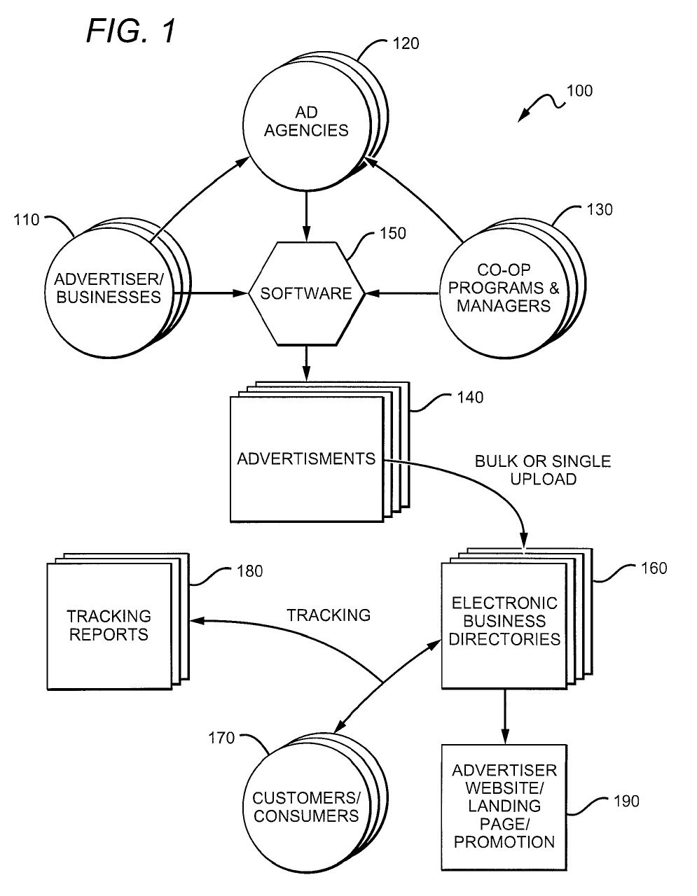

FIG. 1 shows a schematic of an advertising process 100 that generally includes advertisers 110, advertisement agencies 120, co-op programs 130, advertisements 140 generated by the software 150, electronic business directories 160, customers/consumers 170, tracking systems and reports 180, and advertiser website/landing page/promotion 190.

In preferred embodiments, advertisers 110 would tend to be businesses that have limited reach in terms of geography and/or business categories, and relatively small advertising budgets. Examples include local hardware stores, car repair shops, hairstylists and other small businesses for whom launching an independent advertisement campaign or hiring advertisement agency is either unaffordable or makes no economic sense.

Because of their relatively small advertising budgets, such advertisers would tend to advertise on electronic directories where they need only provide a name, logo, and other minimal information. The services contemplated herein can provide significant benefits to such advertisers because the service can cost-effectively compare costs and expected benefits from multiple publishers, automatically generate advertisements in the proper formats, and even provide guidance as to cooperative advertising programs.

Although advertising agencies 120 are entirely optional, it is contemplated that they can generate leads for the system. This is advantageous to the advertisers because they can have interactions with agencies that ordinary would pass them by. But this is also advantageous to the agencies because they can garner at least some income from advertisers with whom they could not realistically do business, and provides a way of farming for advertisers that might eventually grow into more substantial clients.

Where it is cost-effective, advertising agencies can also serve as facilitators between advertisers and co-op programs, and between advertisers and publishers. For example, a given advertising agency might aggregate hundreds or thousands of advertisements for upload to publishers.

Cooperative advertising programs 130 are arrangements in which advertisement costs are divided between two or more parties. Usually, such programs are offered by manufacturers to their wholesalers or retailers, as a means of encouraging those parties to advertise the product. For example, a given the cooperative advertising program might match the advertising fees spend by a local advertiser, merely by virtue of the advertiser including a brand name logo in its advertisement.

In this application all types of cooperative advertising are contemplated. This includes all of the possible different size matchings (local business with nationwide retailer, national retailer with national brands, etc), and also all of the possible different product fields (transportation, foods, home improvements, electronics, etc). This also includes all manner of restrictions, including for example exclusive distribution, non-competitive products, product image and so forth. Still further, a given cooperative advertisement can readily include two, three or even more advertisers in one advertisement.

The software 150 comprises one or more computer programs that has interfaces with advertisers 110, co-op programs, 130, advertisement agencies 120, and electronic business directories 160. The software captures information via those interfaces and in turn generates advertisements 140 according to the captured information. In preferred embodiments, the software is an internet-based application wherein the interfaces are websites accessible via the World Wide Web. The software provides different skins to any of the different players in advertising space, including for example advertisers, advertisement agencies, co-op program directories, and electronic business index operators.

The software 150 also provides a variety of other tools to assists the various players of the cooperative advertising program. Tools are provided to ensure that the advertisements generated meet the requirements of the advertisers, co-op programs, ad-agencies and electronic business directories. The software further comprises tools to assist users in the selection of co-op programs to participate and electronic business directories to place advertisements in. The software also provides tracking reports 180, estimate return on investment (ROI) and other useful analysis. Still further, the software provides a bulk upload facility for transmitting a bundle of advertisements to a media provider.

Advertisements 140 comprise at least a portion of the advertiser-specific information and a first logo required by the selected co-op advertising program. The information from an advertiser can advantageously include a name, contact information, a logo, a tag line, a map or other business information. The information from a co-op program can also include a brand name logo or other business information. In preferred embodiments, the advertisement is a webpage in which a customer 170 viewing the webpage can click on logos, texts or other hyperlinked entities and be routed to a website/landing page/promotion of an advertiser 190.

The advertisement 140 displays the information in conformance with the standards and specifications of the chosen co-op program(s) and the electronic business directory 160 into which the advertisement is placed. Such standards and specifications typically include both formatting restrictions (e.g., shape, minimum and maximum sizes of the advertiser's logo) and content restrictions (e.g., number and type of images, and minimum and maximum word counts).

The generated advertisements 140 are assured to conform to these requirements by the use of the software 150. In preferred embodiments, tools are provided to automatically resize logos and other graphical information from the advertisers to conform to requirements; the resized graphics is then provided as previews to advertisers so they can decide whether to accept the resized graphics or supply modified graphics. It is further contemplated that a tool provides warning, error or other failure messages to advertisers when proposed advertisements fail to conform to requirements. Before an advertisement is deployed or published in electronic business directories 160, a tool provides a preview of the automatically generated advertisement to the relevant advertisers, co-op programs, advertisement agencies and electronic business directories for approval.

Electronic business directories 160 can include very different types of indices such as internet yellow pages, search engines business indices, ad-serving networks and other partner advertising platform/sites. Other advertising mediums amenable to electronic tracking and reporting are also contemplated, such as printed yellow pages, printed newspapers, televised commercials and other advertising mediums capable of informing viewers how to contact advertisers electronically, for example by phone, email, internet website or other electronic means of communication.

In preferred embodiments, an electronic business directory 160 informs advertisers of its requirements by uploading them via a tool provided by the software 150. Electronic business directory typically have a variety of advertising spaces available with different requirements, and are more than happy to upload a list of requirements and available spaces.

Customers/Consumers 170 are viewers of electronic business directories 160 who respond to advertisements 140 placed inside the directories. In preferred embodiments, a customer is an on-line visitor to a website of the electronic business directory, wherein the website comprises an automatically generated advertisement 140 from the software 150. Such a customer might respond to the advertisement by clicking on logos, texts or other hyperlinked objects in the advertisements and be routed to a website/landing page/promotion of an advertiser 190. The customer might also respond to the advertisement by other electronic means of communication such as visiting a second website, calling a toll free number, sending an email and so forth.

A tracking system 180 is provided to track customer responses to generated advertisements 140. In preferred embodiment, the responses of customers/consumers are tracked by the number of impressions, clicks, calls, emails and other raw statistics. The tracking system then generates reports of the statistics to at least one of advertisers, advertisement agencies and co-op program mangers. It is contemplated that such report can be customized. A viewer of the report might, for example, elect to view monthly, weekly, or daily statistics. Still further, the viewer might elect to view statistics on a particular advertisement, a customized list of advertisements, all advertisements placed with an electronic business directory, all advertisements belonging to a specific co-op program, all advertisements belonging to a specific advertiser, or other possible collections of advertisements. In addition to reporting raw statistics such as clicks and impressions, preferred tracking system can advantageously generate secondary statistics such as estimated return on investment (ROI) and other statistics.

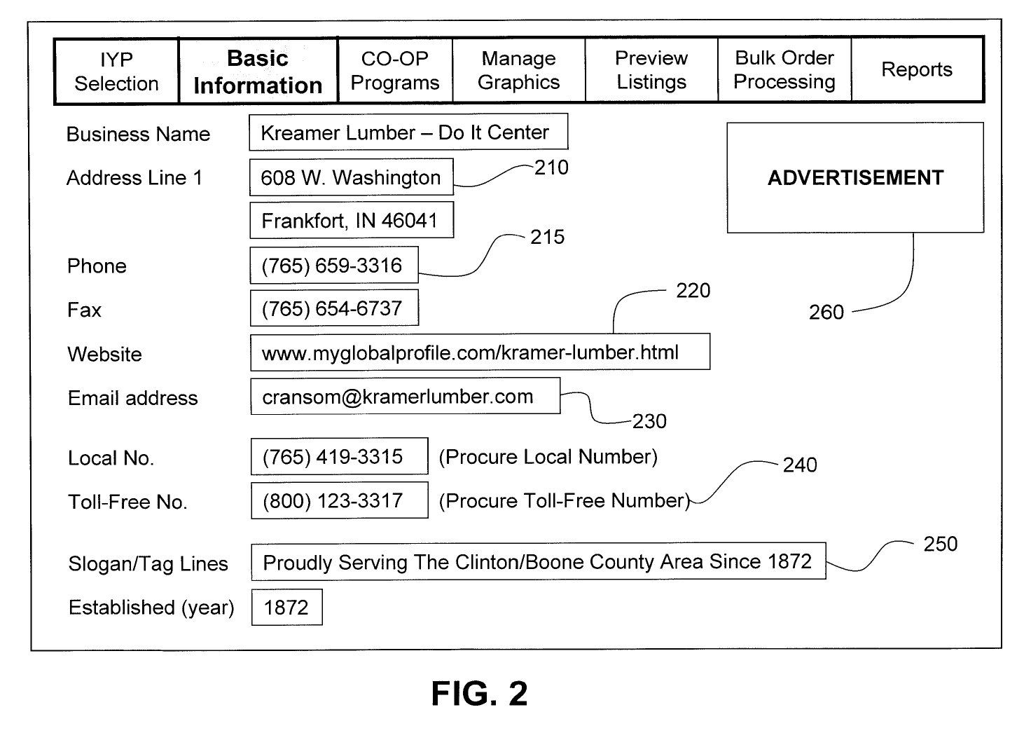

FIG. 2 is a screen shot of an interface through which an advertiser can enter basic contact information, including for example, physical address 210, contact phone number 215, web address 220, email address 230, and a toll-free or local phone number 240 for purpose of tracking customer responses via telephone. In this particular embodiment, advertisers can also enter a slogan or a tag line 250, an advertisement heading 260, or other advertising information.

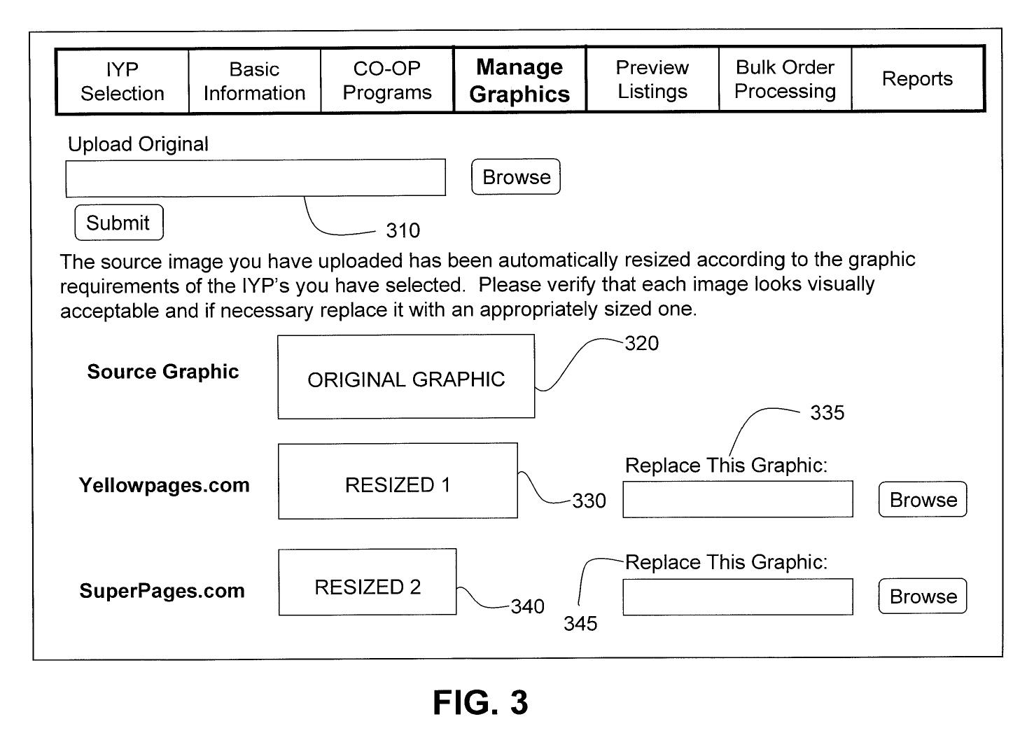

FIG. 3 is a screen shot of an interface that displays different formats of an advertisement in conformance with specifications and standards of the chosen publishers. In this embodiment the advertiser supplies the software with the file location of the source graphic 310. The software then displays the uploaded source graphic 320 for the advertiser to review, and automatically resizes the graphic to conform to dimensional requirements of the chosen publisher. The advertiser can then preview the resized graphics 330 and 340, and decide whether to accept the modified graphics, or replace them with advertiser's own graphics, 335 and 345.

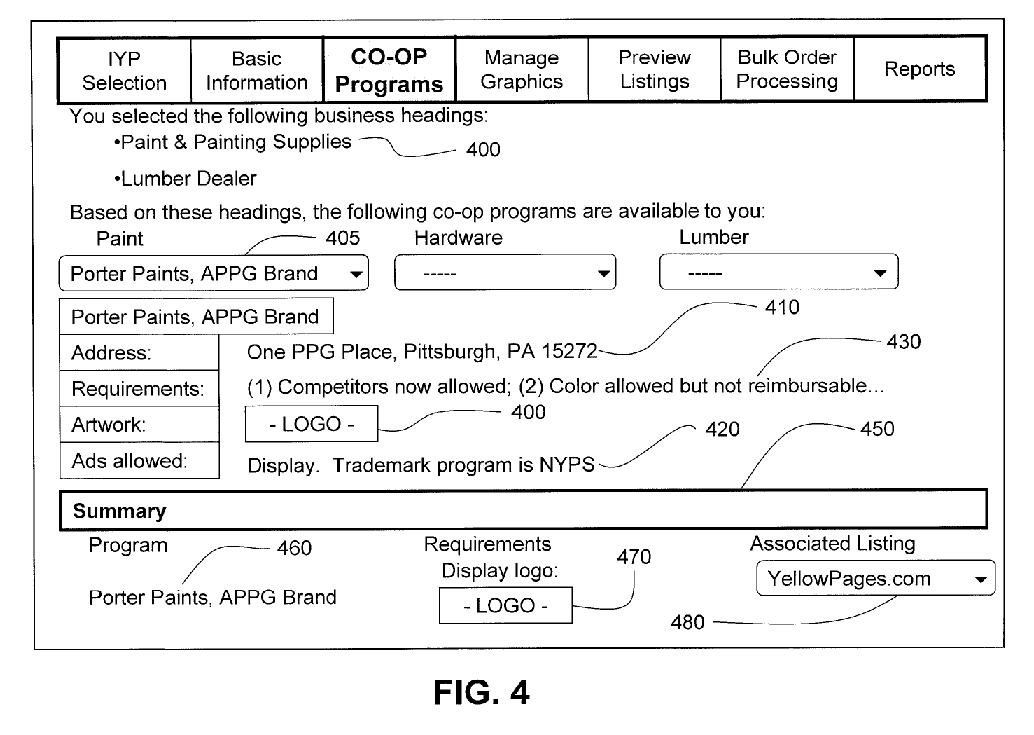

FIG. 4 is a screen shot of an interface that displays requirements for a cooperative advertising program. In this particular example, the software displays the business categories 400 selected by the advertiser, and suggests a listing 405 of suitable co-op programs for selection by the advertiser. In this case, the single exemplary entry should be interpreted as a list of multiple entries. The interface gives the detail information 410 of the selected co-op program, including a list of logos 440 for the advertiser to incorporate if it wishes to participate. The interface also displays the co-op program's format requirement 430 and other restrictions 420. The result of the advertiser's selection is depicted in a summary 450, which includes a list of the co-op programs already selected 460, the logos of the corresponding co-op programs, and the electronic business directories 480 where the generated cooperative advertisement are to be placed. It is especially preferable that the co-op program listing 405 includes a plurality of unrelated choices, and at least one member of the listing relates to a company that has no substantial business relationship with the advertiser.

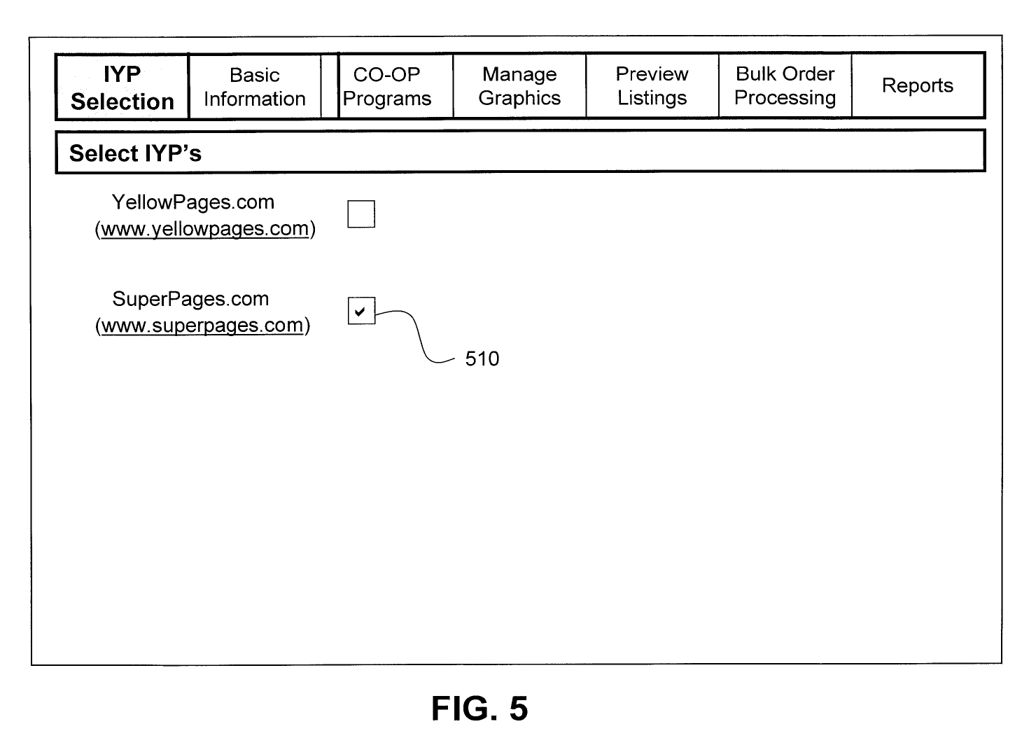

FIG. 5 is a screen shot of an interface through which a user selects publishers to receive and publish a given advertisement. A list 510 of electronic business directories is made available to advertisers or co-op program managers for selection. In preferred embodiments, the electronic business index is selected from the list consisting of an Internet Yellow Pages and a search engine business index.

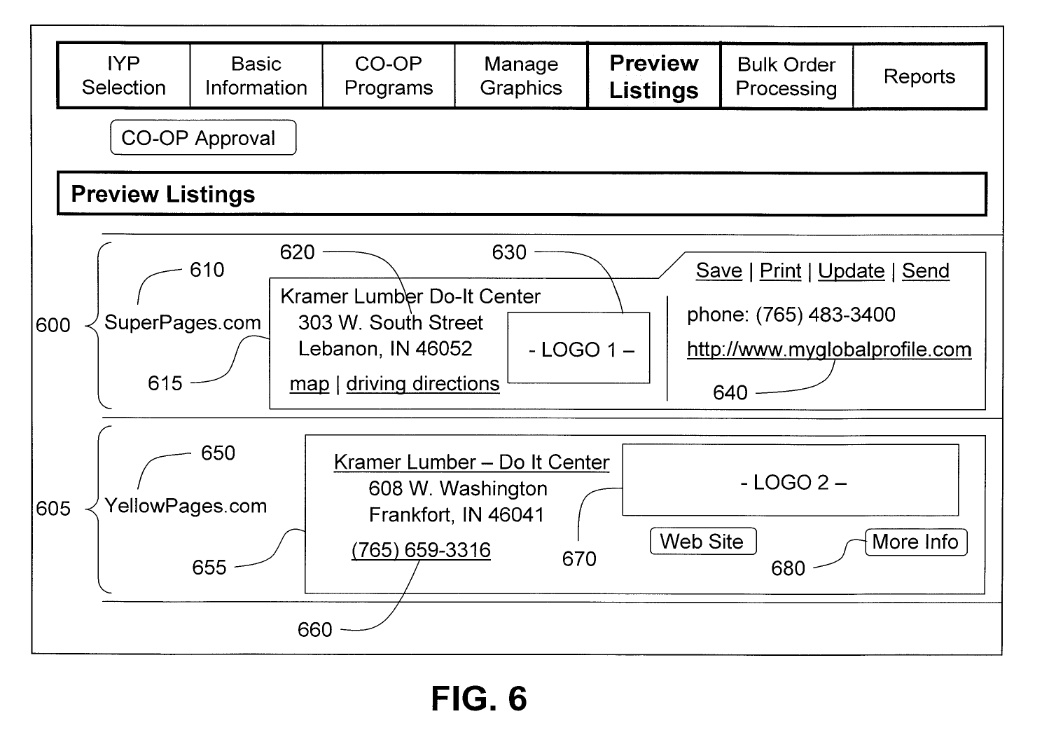

FIG. 6 is a screen shot of an interface that previews a given advertisement in formats suitable for different publishers. The first preview 600, displays the name of a first electronic business directory 610 along side a preview of a first advertisement 615, which include textual advertiser information 620, a co-op program's logo 630 and a textual contact information 640, all in conformance with requirements of the first electronic business directory. The second preview 605 likewise includes the name of a second electronic business directory 650, and a preview of a second advertisement 655. The second advertisement comprises second textual advertiser information 660, an advertiser's logo 670 and buttons 680 linking the advertisement directly to a website, all in conformance with requirements of the second electronic business directory.

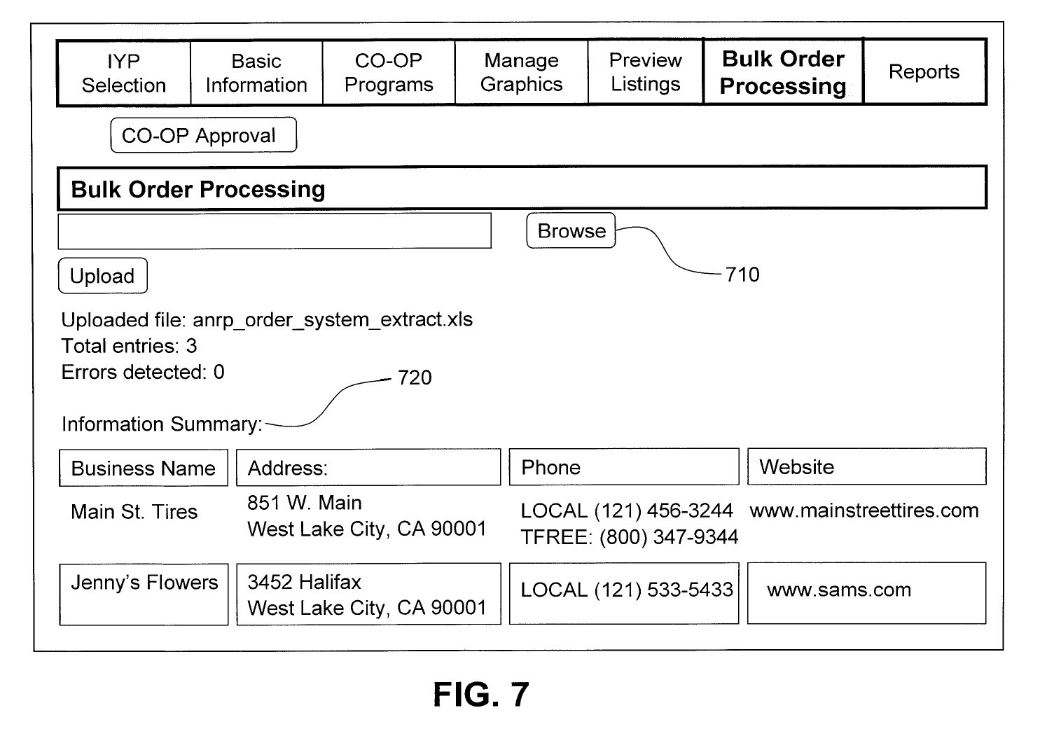

FIG. 7 is a screen shot of an interface of a bulk upload facility for transmitting the advertisement along with other advertisements to a media provider. Advertisers, co-op program mangers, advertisement agencies or other users of the software may use this interface to upload multiple advertisements from multiple advertisers in bulk by uploading a bulk upload file 710. The interface also provides a summary 720 of the advertisements uploaded. The interface skin of FIG. 7 is designed to be especially useful for co-op managers. It is generally contemplated that the tool 150 would provide different interface skins to at least two of the advertiser 110, an advertising agency 120, a co-op program manager 130, a national brand manager, and a media provider for displaying summary customer tracking information or other functionalities.

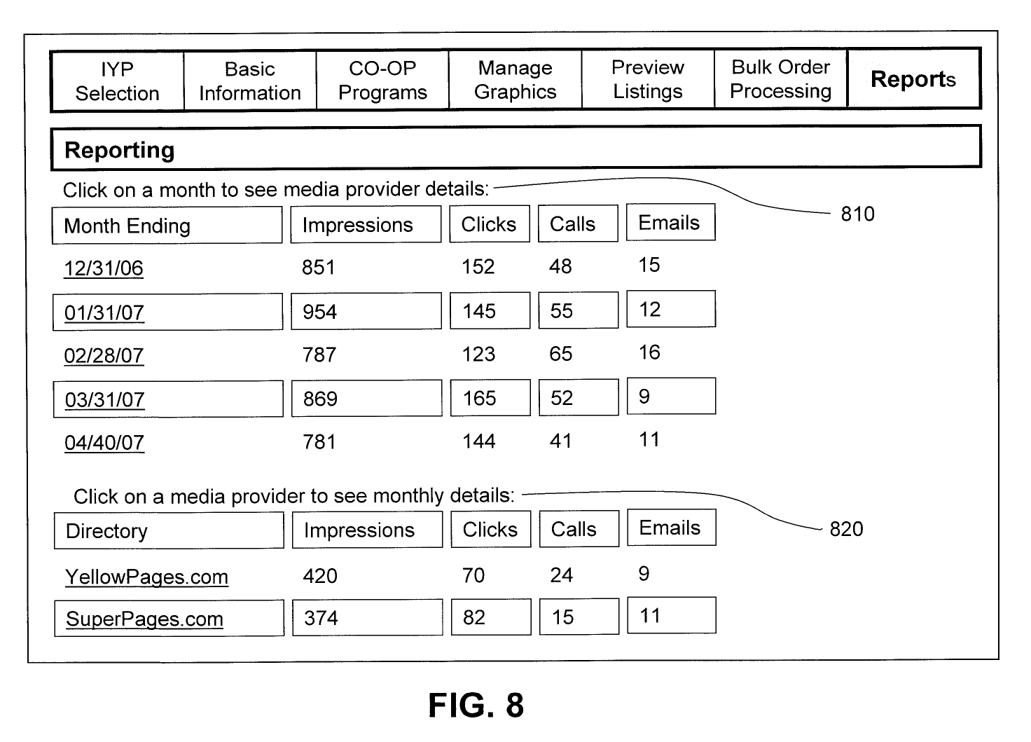

FIG. 8 is also a screen shot of the software in an interface skin designed for advertisers. In this case the display shows tracking information for a given advertisement. An advertiser has access to the monthly tally of impressions, clicks, calls and emails in response to the advertisement in a first report 810. Alternatively, an advertiser may track the responses to its advertisements placed in different electronic business directories in a second report 820.

Thus, specific embodiments and applications of systems and methods of facilitating advertising to multiple different electronic business indices have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of facilitating advertising on a public package switched network, comprising:
capturing advertiser-specific information for an advertiser;
using at least a first portion of the advertiser-specific information to select a listing of suitable co-op advertising programs; the listing including a plurality of unrelated choices, at least one of which relates to a company that has no substantial business relationship with the advertiser;
providing an electronic interface that allows a user to select from the listing a co-op advertising program; and
a software tool that facilitates at least partially automated production of an advertisement, using at least a second portion of the advertiser-specific information and a first logo required by the selected co-op advertising program.

2. The method of claim 1, wherein the advertisement further includes a logo of the advertiser, and a third logo associated with another, unrelated co-op advertising program.

3. The method of claim 1, wherein the step of providing the software tool comprises providing the tool to an advertising agent for use on behalf of its clients.

4. The method of claim 1, wherein the step of producing the advertisement comprise providing the advertisement according to specifications and standards of an electronic business index.

5. The method of claim 4, wherein the electronic business index is selected from the list consisting of an Internet Yellow Pages and a search engine business index.

6. The method of claim 1, further comprising creating an advertising campaign that involves using different versions of the advertisement in different electronic business indices.

7. The method of claim 1, further comprising providing a bulk upload facility for transmitting the advertisement along with other advertisements to a media provider.

8. The method of claim 6, further comprising providing a facility for tracking and reporting customer responses to the advertisements.

9. The method of claim 6, further comprising providing different interface skins for displaying summary customer tracking information to at least two of the advertiser, an advertising agency, a co-op program manager, a national brand manager, and a media provider.
